(19) United States
(12) Patent Application Publication
(10) Pub. No.: US 2007/0294440 A1
(43) Pub. Date: Dec. 20, 2007

(54) Sd (Secure Digital) Card and Host Controller

(76) Inventor: Chouyuu Haku, Osaka (JP)

Correspondence Address: MCDERMOTT WILL & EMERY LLP, 600 13TH STREET, NW, WASHINGTON, DC, 20005-3096, US

(21) Appl. No.: 11/665,602

(22) PCT Filed: Jan. 30, 2006
(86) PCT No.: PCT/JP06/01492

§ 371 Date: Apr. 18, 2007

(30) Foreign Application Priority Data
Feb. 7, 2005 (JP) 2005-031107

(51) Int. Cl. G06F 13/38; G06F 3/08; G06K 17/00; G06K 19/077

(52) U.S. Cl. 710/62

(57) ABSTRACT

Provided is an SD card that can transfer data at a faster speed than a conventional SD card by a data transfer method that is different from a conventional one. Among the four terminals used in the data transfer by the conventional method, respective two terminals are made into pairs. By using the respective pairs of terminals, a data transfer can be performed by the differential signal method. A switching mechanism is provided to switch between the normal method and the differential signal method in a data transfer. When both of the SD card and the host controller with the SD card inserted therein can perform a data transfer by the differential signal method, the data transfer is performed by the differential signal method.

### TECHNICAL FIELD

The present invention relates to an SD card and a host controller to which the SD card is connected, and especially to a data input/output method.

### BACKGROUND ART

In recent years, the storage capacity of SD memory cards has been increased, and now SD memory cards with 512 MB or 1 GB of capacity are in markets. With respect to the data transfer speed, SD memory cards with 20 MB/s of data transfer speed are in markets.

Document 1 discloses a technology for enabling a host apparatus to use both an SD memory card and an SDUSB card with a same slot.
Document 1: Japanese Patent Application Publication No. 2001-307025.

### DISCLOSURE OF THE INVENTION

The Problems the Invention Is Going to Solve

Meanwhile, as the capacity of the SD memory cards has been increased, a conventional data transfer speed of the SD memory cards has become unsatisfactory.

The first object of the present invention is therefore to provide an SD card with which data can be transferred at a faster speed than with conventional SD cards. Also, the second object of the present invention is to provide an external device that corresponds to and is connected with the SD card.

Means to Solve the Problems

The above object is fulfilled by an SD card that includes a plurality of terminals and performs data input/output while being inserted in an external device, the SD card comprising: a normal input/output control unit operable to perform data input/output one bit by one bit via one terminal; a differential signal input/output control unit operable to perform data input/output one bit by one bit via two terminals by a differential signal method; and a switching unit operable to cause either of the normal input/output control unit and the differential signal input/output control unit to perform data input/output by switching therebetween in accordance with a request from the external device.

It should be noted here that “input/output” means either input or output.

### EFFECTS OF THE INVENTION

With the above-stated structure, the SD card can send and receive data to/from the host controller to which the SD card is connected, by either of the conventional method and the differential signal method. Here, the data transfer performed by the differential signal method is faster than the data transfer performed by the conventional data communication method.

In the conventional data transfer method used in conventional SD cards (hereinafter, the conventional transfer method is referred to as normal method), one signal line is used to transfer one bit of data, and four signal lines in total are used to transfer four bits of data. Use of the normal method has the following problems. That is to say, when the normal method is used to transfer data at a high speed, a high frequency occurs to adversely influence the peripheral devices. Conversely, the data transfer performed by the normal method in such a condition is easy to receive influences from the peripheral devices and is susceptible to disturbances, which increases the data corruption rate.

On the other hand, the differential signal method uses two signal lines to transfer one bit of data, and, due to this structure, is resistant to noise, and can transfer data at a high speed. Also, with the structure being different from the normal method in that the two signal lines transfer data whose values are antiphase to each other, the differential signal method makes it possible to cancel out the influences of the high frequencies generated therein, reduce the influence to the peripheral devices, and make the data transfer resistant to disturbances.

In the above-described SD card, the terminal via which the normal input/output control unit may perform data input/output is one of the two terminals via which the differential signal input/output control unit performs data input/output.

With the above-stated structure, the data transfer by the normal method and the data transfer by the differential signal method can share the same terminals, and there is no need to newly add terminals to the conventional SD cards. Accordingly, there is no need to make space in the SD cards for providing additional terminals in the manufacturing process, and no additional manufacturing cost arises.

In the above-described SD card, the two terminals may be rectangular metal pieces arranged such that length directions thereof are substantially parallel to each other.

With the above-stated structure in which the two terminals are arranged to be substantially parallel to each other, it is possible to properly cancel out the influences of the high frequencies generated therein when data input/output is performed by the differential signal method.

In the above-described SD card, the two terminals may be arranged to be adjacent to each other.

With the above-stated structure in which the two terminals are arranged to be adjacent to each other, it is possible to cancel out more effectively the influences of the high frequencies generated therein when data input/output is performed by the differential signal method.

In the above-described SD card, the plurality of terminals may include a reception terminal operable to receive the request from the external device in which the SD card is inserted.

With the above-stated structure, the SD card can send or receive data to/from the external device to which the SD card is connected, in accordance with a request received from the external device.

The above-described SD card may further comprise: a storage unit storing data; and another normal input/output control unit, wherein the normal input/output control units perform data input/output one bit by one bit respectively via the two terminals via which the differential signal input/output control unit performs data input/output, and the switching unit causes the differential signal input/output control unit to perform data input/output two times by time division between the storage unit and the external device in which the SD card is inserted, to transfer an amount of data that can be transferred by the two normal input/output control units at one time.

With the above-stated structure, the SD card can input or output the same amount of data by either the normal method or the differential signal method. It should be noted here that since the differential signal method is higher in data transfer rate than the normal method, the differential signal method does not take more time to input/output data than the normal method.

In the above-described SD card, the differential signal input/output control unit may perform data input/output by a voltage differential signal method in which a data value is defined by a difference between voltages applied to two terminals.

With the above-stated structure, the SD card can support the voltage differential signal method in which a data value is determined by a difference between voltage values.

In the above-described SD card, the differential signal input/output control unit may perform data input/output by a current differential signal method in which a data value is defined by a difference between values of currents that flow in two terminals.

With the above-stated structure, the SD card can support the current differential signal method in which a data value is determined by a difference between current values.

In the above-described SD card, the differential signal input/output control unit may perform data input/output by either of a voltage differential signal method and a current differential signal method, wherein in the voltage differential signal method, a data value is defined by a difference between voltages applied to two terminals, and in the current differential signal method, a data value is defined by a difference between values of currents that flow in two terminals.

With the above-stated structure, the SD card can input or output data by the differential signal method regardless of whether the external device as a communication partner uses the voltage differential signal method or the current differential signal method.

In the above-described SD card, the differential signal input/output control unit may perform data input/output by changing a data transfer speed as necessary.

With the above-stated structure, the SD card can perform data input/output at any of a plurality of data transfer speeds.

In the above-described SD card, the differential signal input/output control unit may change the data transfer speed in accordance with a request that indicates a data transfer speed and is received by the reception terminal from the external device in which the SD card is inserted.

With the above-stated structure, the SD card can perform data input/output at a data transfer speed requested by the external device.

The above-stated object is also fulfilled by a host controller that performs a data communication with an SD card inserted therein, via a plurality of terminals provided in the host controller, the host controller comprising: a normal input/output control unit operable to perform data input/output one bit by one bit via one terminal; a differential signal input/output control unit operable to perform data input/output one bit by one bit via two terminals by a differential signal method; a reading unit operable to read information indicating whether the inserted SD card supports data input/output by the differential signal method; and a switching unit operable to cause either of the normal input/output control unit and the differential signal input/output control unit to perform data input/output by switching therebetween in accordance with whether the inserted SD card supports data input/output by the differential signal method.

With the above-stated structure, the host controller can judge whether or not the SD card inserted therein supports data input/output by the differential signal method, and perform data input/output by a method that is determined depending on the inserted SD card.

In the above-described host controller, the terminal via which the normal input/output control unit performs data input/output is one of the two terminals via which the differential signal input/output control unit performs data input/output.

With the above-stated structure, the data transfer by the normal method and the data transfer by the differential signal method can share the same terminals in the host controller, and there is no need to newly add terminals to the conventional host controllers. Accordingly, there is no need to make space in the host controllers for providing additional terminals in the manufacturing process, and no additional manufacturing cost arises.

In the above-described host controller, the two terminals may be rectangular metal pieces arranged such that length directions thereof are substantially parallel to each other.

With the above-stated structure in which the two terminals are arranged to be substantially parallel to each other, it is possible in the host controller to properly cancel out the influences of the high frequencies generated therein when data input/output is performed by the differential signal method.

In the above-described host controller, the two terminals may be arranged to be adjacent to each other.

With the above-stated structure in which the two terminals are arranged to be adjacent to each other, it is possible in the host controller to cancel out more effectively the influences of the high frequencies generated therein when data input/output is performed by the differential signal method.

In the above-described host controller, the plurality of terminals may include a conveyance terminal operable to convey a request to the inserted SD card.

With the above-stated structure, the host controller can convey to the inserted SD card, for example, a request to perform data input/output by the normal method or by the differential signal method.

The above-described host controller may further comprise: a storage unit storing data; and another normal input/output control unit, wherein the normal input/output control units perform data input/output one bit by one bit respectively via the two terminals via which the differential signal input/output control unit performs data input/output, and the switching unit causes the differential signal input/output control unit to perform data input/output two times by time division between the storage unit and the external device in which the SD card is inserted, to transfer an amount of data that can be transferred by the two normal input/output control units at one time.

With the above-stated structure, the host controller can input or output the same amount of data by either the normal method or the differential signal method. It should be noted here that since the differential signal method is higher in data transfer rate than the normal method, the differential signal method does not take more time to input/output data than the normal method.

In the above-described host controller, the differential signal method may be a voltage differential signal method in which a data value is defined by a difference between voltages applied to two terminals.

With the above-stated structure, the host controller can support the voltage differential signal method in which a data value is determined by a difference between voltage values.

In the above-described host controller, the differential signal method may be a current differential signal method in which a data value is defined by a difference between values of currents that flow in two terminals.

With the above-stated structure, the host controller can support the current differential signal method in which a data value is determined by a difference between current values.

In the above-described host controller, the differential signal input/output control unit may perform data input/output by either of a voltage differential signal method and a current differential signal method, wherein in the voltage differential signal method, a data value is defined by a difference between voltages applied to two terminals, and in the current differential signal method, a data value is defined by a difference between values of currents that flow in two terminals.

With the above-stated structure, the host controller can input or output data by the differential signal method regardless of whether the inserted SD card uses the voltage differential signal method or the current differential signal method.

In the above-described host controller, the differential signal input/output control unit may perform data input/output by changing a data transfer speed as necessary.

With the above-stated structure, the host controller can perform data input/output by changing the data transfer speed in correspondence with the SD card inserted therein.

In the above-described host controller, the differential signal input/output control unit may convey, via the conveyance terminal, a request that indicates a data transfer speed to the inserted SD card, and performs data input/output at the data transfer speed indicated by the request.

With the above-stated structure, the host controller can perform data input/output with the SD card inserted therein at a data transfer speed that the host controller specifies.

The above-described host controller may further comprise a voltage supply unit operable to supply a voltage to the SD card for an operation thereof, wherein the switching unit changes the voltage to be supplied to the SD card, depending on which of the normal input/output control unit and the differential signal input/output control unit performs data input/output.

With the above-stated structure, the host controller can change the voltage to be supplied to the SD card, depending on which of the normal method and the differential signal method is used. The differential signal method enables the data input/output to be performed with less supply of voltage than the normal method, thus reducing the supply of voltage and producing an advantageous effect of power saving.

The above-described host controller may further comprise a differential signal converting unit operable to generate or combine differential signals, wherein data lines connecting the differential signal converting unit with the two terminals, via which the differential signal input/output control unit performs data input/output, are provided substantially in parallel with each other.

With the above-stated structure of the host controller in which data lines connecting the differential signal converting unit with the two terminals are provided substantially in parallel with each other, it is possible to cancel out more effectively the influences of the high frequencies generated therein when data input/output is performed by the differential signal method.

In the above-described host controller, the reading unit may include: a voltage generating unit operable to generate a voltage that is higher than a voltage used for a data transfer by the differential signal input/output control unit; an output unit operable to output the voltage generated by the voltage generating unit to the inserted SD card; and a response reading unit operable to read a response waveform of a response of the SD card to the voltage output by the output unit, for a predetermined time period, wherein if the response reading unit reads a response waveform indicating that the inserted SD card supports data input/output by the differential signal method, the switching unit causes the differential signal input/output control unit to perform data input/output.

With the above-stated structure in which the host controller sends a predetermined amount of voltage to the SD card for a predetermined time period, the SD card returns a response with a waveform for another predetermined time period to indicate that the SD card supports data input/output by the differential signal method, and the host controller can recognize whether or not the SD card inserted therein supports data input/output by the differential signal method, before actually operating onto the SD card by the differential signal method.

The above-stated object is also fulfilled by a data input/output method for an SD card, comprising: a normal input/output control step for performing data input/output one bit by one bit via one terminal; a differential signal input/output control step for performing data input/output one bit by one bit via two terminals by a differential signal method; and a switching step for causing either of the normal input/output control unit and the differential signal input/output control unit to perform data input/output by switching therebetween in accordance with a request from an external device in which the SD card is inserted.

The above-stated object is also fulfilled by a data input/output method for a host controller that performs a data communication with an SD card inserted therein, via a plurality of terminals provided in the host controller, the data input/output method comprising: a normal input/output control step for performing data input/output one bit by one bit via one terminal; a differential signal input/output control step for performing data input/output one bit by one bit via two terminals by a differential signal method; a reading step for reading information indicating whether the inserted SD card supports data input/output by the differential signal method; and a switching step for causing either of the normal input/output control unit and the differential signal input/output control unit to perform data input/output by switching therebetween in accordance with whether the inserted SD card supports data input/output by the differential signal method.

The above-stated object is also fulfilled by a data input/output program for causing a computer loaded in an SD card to perform data input/output, the data input/output program causing the computer to perform: a normal input/output control step for performing data input/output one bit by one bit via one terminal; a differential signal input/output control step for performing data input/output one bit by one bit via two terminals by a differential signal method; and a switching step for causing either of the normal input/output control unit and the differential signal input/output control unit to perform data input/output by switching therebetween in accordance with a request from an external device in which the SD card is inserted.

The above-stated object is also fulfilled by a data input/output program for causing a computer loaded in a host controller to perform a data communication with an SD card inserted therein, via a plurality of terminals provided in the host controller, the data input/output program causing the computer to perform: a normal input/output control step for performing data input/output one bit by one bit via one terminal; a differential signal input/output control step for performing data input/output one bit by one bit via two terminals by a differential signal method; a reading step for reading information indicating whether the inserted SD card supports data input/output by the differential signal method; and a switching step for causing either of the normal input/output control unit and the differential signal input/output control unit to perform data input/output by switching therebetween in accordance with whether the inserted SD card supports data input/output by the differential signal method.

With the above-stated structure of method or program, the SD card or the host controller that performs data input/output with the SD card inserted therein can perform data input/output either by the normal method or the differential signal method, and can change the method depending on whether the communication partner supports the differential signal method.

### BRIEF DESCRIPTION OF THE DRAWING

FIG. 1 shows the structure of the SD card being connected to the host controller.

FIGS. 2A-2C show pin arrangement tables that show the pin arrangements in the SD card.

FIGS. 3A and 3B show waveforms of voltages applied to two terminals used for differential signals.

FIG. 4 shows the structure of the switching apparatus.

FIGS. 5A and 5B show waveforms that are used to determine whether or not the SD card supports the differential signal method.

FIG. 6 is a flowchart showing the procedures of the mode setting operation in the SD card.

FIG. 7 is a flowchart showing the procedures of the data transfer operation in the SD card.

FIG. 8 is a flowchart showing the procedures of the mode setting operation in the host controller.

FIG. 9 is a flowchart showing the procedures of the data transfer operation in the host controller.

FIGS. 10A and 10B show waveforms of electric currents flowing in two terminals used for differential signals.

### DESCRIPTION OF CHARACTERS

1-9, 11-19 connection terminals
100 SD card
101 interface driver
102 memory
120 host controller
130 host apparatus
140 SD card slot
400, 410, 420, 430 8-bit buffers
401 8-bit-to-4-bit parallel-to-serial converter
402, 412, 422, 432 4-bit buffers
403, 413, 423, 433 NAND circuits
404, 414, 424, 434 communication method signal lines
405, 415, 425, 435 command content signal lines
406, 416 normal clock input lines
411 4-bit-to-8-bit serial-to-parallel converter
421 8-bit-to-2-bit parallel-to-serial converter
426, 436 high-speed clock input lines
427, 428 differential signal generators
431 2-bit-to-8-bit serial-to-parallel converter
437, 438 differential signal restoring units

### BEST MODE FOR CARRYING OUT THE INVENTION

The following describes an SD card as an embodiment of the present invention, and a host controller to which the SD card is connected, with reference to the attached drawings.

### Embodiment

<Outline>

The SD card of the present invention provides data input/output by a differential signal method, in addition to use of conventional data input/output methods with SD cards. This feature is realized by changing the data input/output methods depending on whether the host controller to which the local card is connected supports the data input/output by the differential signal method.

The host apparatus such as a personal computer needs to have a structure corresponding to the structure of the SD card. Accordingly, such a host apparatus is included in the scope of the present invention.

Here, the data input/output by the differential signal method will be described in detail.

In a normal method, a signal in a one signal line represents “0” or “1” at a time by difference in size of the voltage (for example, 0V or 3V), when data is input/output one bit by one bit.

As described earlier, when such a data transfer is performed at a high speed, high-frequency waves occur and become susceptible to disturbances. Also, the influence to the peripheral devices is increased. As apparent from this, the transfer speed has a limit.

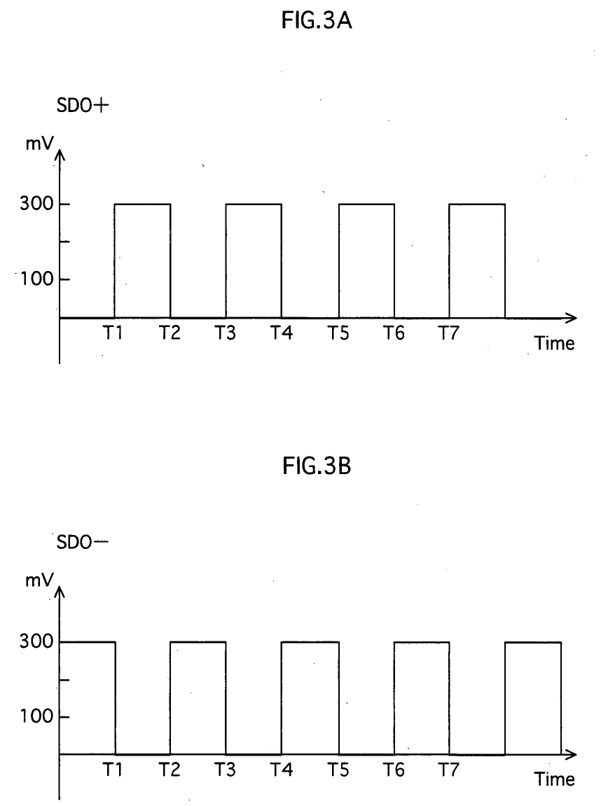

On the other hand, in the differential signal method, two signal lines are used when data is input/output one bit by one bit. According to this method, when the signal shown in FIG. 3A is flown in one signal line, the signal shown in FIG. 3B, which is totally antiphase to the data shown in FIG. 3A, is flown in the other signal line. Then, a difference of one signal from the other signal in voltage value is obtained. If the difference is greater than a threshold value, the data is regarded as “1”; and if the difference is equal to or smaller than the threshold value, the data is regarded as “0”.

It is presumed here that the threshold value is “0”. Then, for example, at times T1-T2 or times T3-T4, a voltage of 300 mV is applied to SDO+ as shown in FIG. 3A, and no voltage is applied to SDO− as shown in FIG. 3B. In this case, the difference of SDO+ from SDO− is obtained as SDO+−SDO−=300−0 =300 mV. Since the difference is a positive value, the data is regarded as “1”.

On the other hand, at times T2-T3 or times T4-T5, no voltage is applied to SDO+ as shown in FIG. 3A, and a voltage of 300 mV is applied to SDO− as shown in FIG. 3B. In this case, the difference of SD0+ from SD0− is obtained as SD0+−SD0−=0−300 =−300 mV.

Since the difference is a negative value, the data is regarded as “0”.

The two signal lines are proved to be in parallel with and adjacent to each other so that the electromagnetic noise and the disturbance electromagnetic noise are cancelled out at the same time. In the case of differential signals, as shown in, FIGS. 3A and 3B, the higher potential is set to 300 mV, and the lower potential is set to 0V. Accordingly, compared with the normal method in which 0V and 3V are used for the same, the voltage supplied from the host apparatus to the SD card for its operation is also reduced.

<Structure>

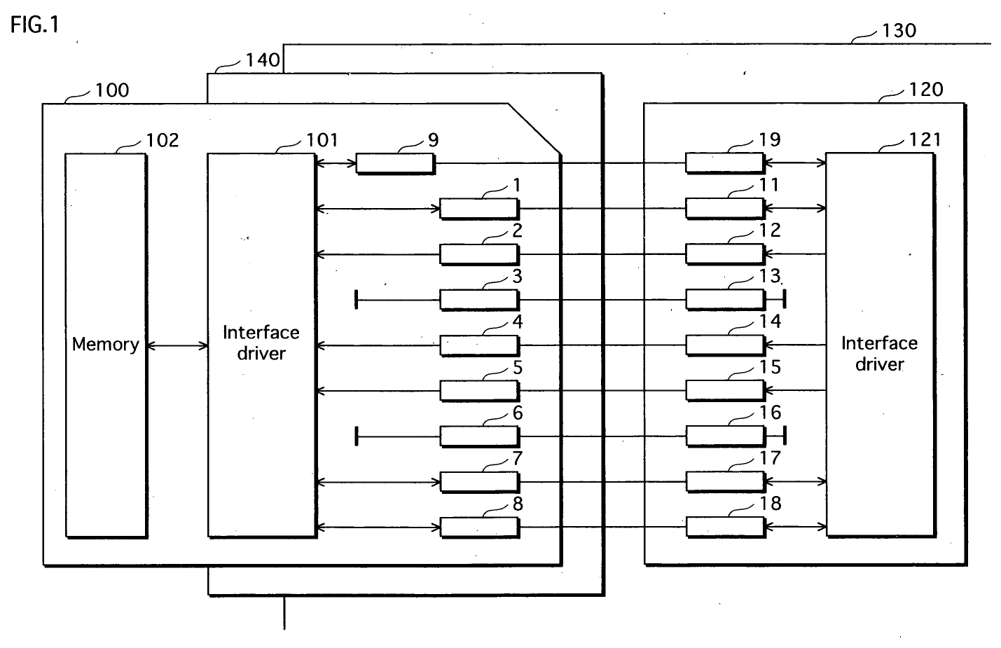

FIG. 1 shows the structure of the SD card connected to the host controller, in the embodiment of the present invention.

An SD card 100 is connected to a host controller 120 in a host apparatus 130, while the SD card 100 is inserted in an SD card slot 140. More specifically, the host apparatus 130 is achieved by a personal computer or a printer with which the SD card 100 can input/output data. Basically, the SD card 100 has the same structure as conventional SD cards.

The SD card 100 includes connection terminals 1-9, an interface driver 101, and a memory 102.

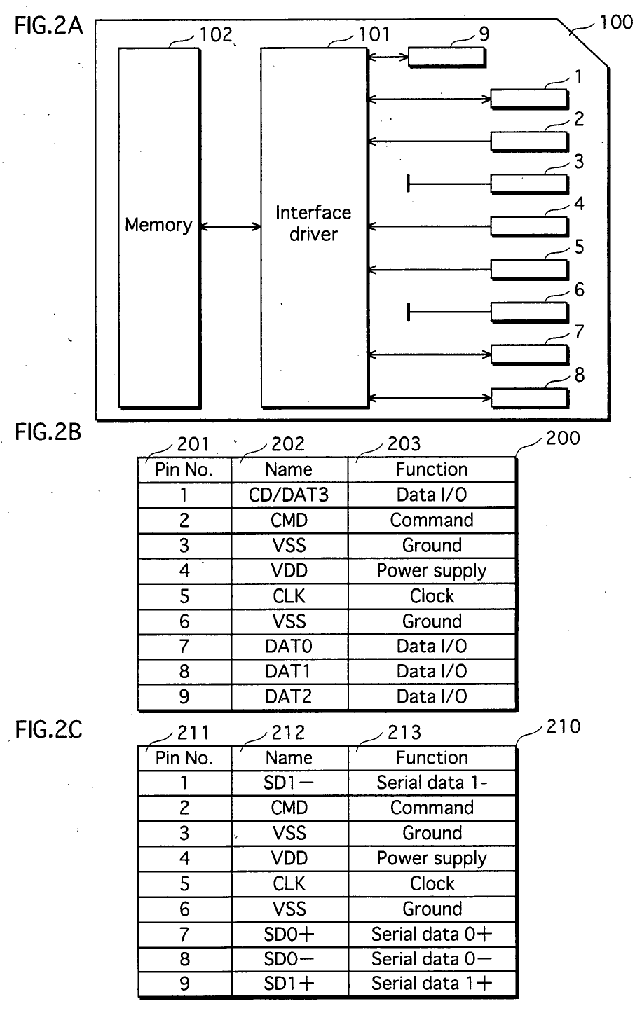

The connection terminals 1-9 are used for data input/output with the host apparatus 130, and for receiving the power supply or commands. The connection terminals 1-9 will be described in more detail with reference to FIGS. 2A-2C. FIG. 2A shows the structure of the SD card 100. FIG. 2B shows the case where a normal data transfer is performed using the connection terminals 1-9. FIG. 2C shows the case where a data transfer is performed based on the differential signal method using the connection terminals 1-9. In the SD card 100 of the present invention, both types of data input/output are available.

FIG. 2B shows a conventional pin arrangement table 200 that shows the pin arrangement for conventional data input/output. In the conventional pin arrangement table 200, the names and functions of pins are respectively provided in the name column 202 and the function column 203 in correspondence with the pin numbers provided in the pin no. column 201. As shown in the table, the connection terminals 1, 7, 8, 9 are used for data input/output. The connection terminal 2 is used for receiving commands. The connection terminals 3 and 6 are grounded. The connection terminal 4 is used for receiving power supply for the operation of the SD card 100. The connection terminal 5 is used for receiving clock inputs.

On the other hand, FIG. 2C shows a differential signal pin arrangement table 210 that shows the pin arrangement for data input/output by the differential signal method. In the differential signal pin arrangement table 210, the names and functions of pins are respectively provided in the name column 212 and the function column 213 in correspondence with the pin numbers provided in the pin no. column 211. The differential signal pin arrangement table 210 differs from the conventional pin arrangement table 200 in that the connection terminals 1 and 9 are used as a pair, and the connection terminals 7 and 8 are used as a pair, where these connection terminals are pins for data input/output, and that each pair of connection terminals is used when data is input/output one bit by one bit. Since the connection terminals 1 and 9 make a pair, the signal that is flown in the connection terminal 9 is antiphase to the signal that is flown in the connection terminal 1. Also, since the connection terminals 7 and 8 make a pair, the signal that is flown in the connection terminal 8 is antiphase to the signal that is flown in the connection terminal 7.

The interface driver 101 controls the SD card 100, and has a function to receive a command from the host apparatus 130 and output data recorded in the memory 102 to the host apparatus 130, and a function to receive data from the host apparatus 130 and write the received data to the memory 102.

The memory 102 stores various types of data. The memory 102 also stores data that was specified by the user in the past. The host apparatus 130 can read or write data from/to the memory 102 in accordance with a protocol defined in the SD card standard. Although not illustrated, the SD card 100 includes a register called SCR (Sd-card Configuration Resister) that stores information indicating that the SD card itself supports the data input/output by the differential signal method. If the SD card 100 does not support the data input/output by the differential signal method, the SCR stores information indicating that the SD card itself performs the data input/output by a normal method. More specifically, the SCR holds a value “1” in an area for indicating the data input/output method if the SD card itself supports the data input/output by the differential signal method, and holds a value “0” in the area if the SD card itself does not support it. It is presumed here that when the SD card supports the data input/output by the differential signal method, the card also supports the data input/output by the normal method.

On the other hand, the host controller 120 has almost the same mechanism as the SD card 100, and has almost the same structure as the SD card slot mechanism for a personal computer or a printer. The host controller 120 includes connection terminals 11-19 that are to connect to the connection terminals 1-9 of the SD card 100, and also includes an interface driver 121. Although not illustrated, the interface driver 121 is connected to the CPU and the memory in the host apparatus 130, and has a function to input/output data with the SD card 100, in accordance with an instruction from the CPU. The functions of the connection terminals of the host controller 120 are the same as those of the SD card 100 that are explained above with reference to FIGS. 2A to 2C.

It should be noted here that FIG. 1 is a schematic representation of the structure, and that in the actuality, the connection terminals of the SD card 100 are contacted with the connection terminals of the host controller.

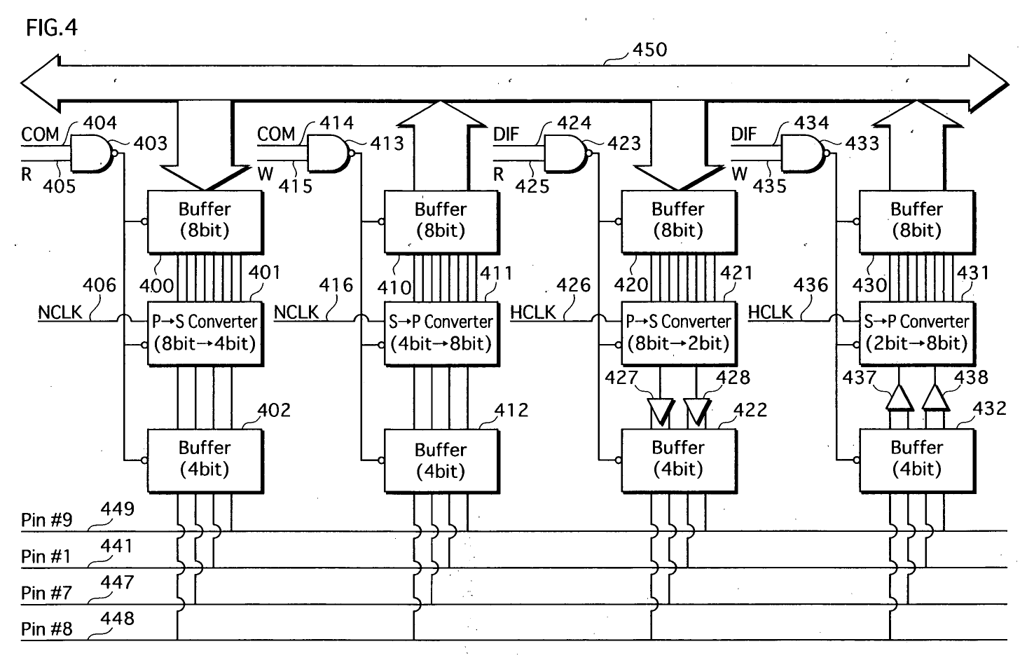

Next, the switching mechanisms, which are included in the interface drivers of the SD card and the host controller for switching between the normal method and the differential signal method for the data input/output, will be explained with reference to FIG. 4.

FIG. 4 shows the structure of a switching mechanism that is held by the interface driver of the SD card or the host controller, and is connected to the connection terminals 1, 7, 8, 9 for data transfer. The switching mechanism includes 8-bit buffers 400, 410, 420 and 430, an 8-bit-to-4-bit parallel-to-serial converter 401, a 4-bit-to-8-bit serial-to-parallel converter 411, an 8-bit-to-2-bit parallel-to-serial converter 421, a 2-bit-to-8-bit serial-to-parallel converter 431, 4-bit buffers 402, 412, 422 and 432, differential signal generators 427 and 428, and differential signal restoring units 437 and 438.

The buffers 400, 410, 420 and 430 have a function to temporarily store data received from the memory via the data bus 450, respectively.

The 8-bit-to-4-bit parallel-to-serial converter 401 has a function to convert data that is sent as parallel data in units of eight bits via the data bus 450, to serial data of four bits. The 4-bit-to-8-bit serial-to-parallel converter 411 has a function to convert data, which is sent as serial data of four bits, to parallel data of eight bits. The 8-bit-to-2-bit parallel-to-serial converter 421 has a function to convert data that is sent as parallel data in units of eight bits via the data bus 450, to serial data of two bits. The 2-bit-to-8-bit serial-to-parallel converter 431 has a function to convert data, which is sent as serial data of two bits, to parallel data of eight bits.

The serial-to-parallel converters and the parallel-to-serial converters are provided because data is transferred by the serial data transfer between the SD card and the host controller, although data is transferred by the parallel data transfer within each of the SD card and the host controller. Also, these converters are provided to convert the unit amount of data for various data transfers. More specifically, in each device, parallel data is transferred in units of eight bits. Between the SD card and the host controller, the data input/output is performed in units of four bits with the normal method, and in units of two bits with the differential signal method.

The differential signal generators 427 and 428 have a function to convert the input data into the data that can be sent by the differential signals. More specifically, the data represented as “0” or “1”is converted into two types of data: (i) data represented as 0V or 300 mV; and (ii) data that is antiphase to the data represented as 0V or 300 mV.

The differential signal restoring units 437 and 438 have a function to convert the input data, which is represented by the two types of differential signals, into the data that can be sent by the normal method as before. Two signal lines, which are used to transfer data from a differential signal generator of a local device to a differential signal restoring unit of a remote device, are arranged to be substantially in parallel with each other to cancel out the influences of the high frequencies that are generated in both of the devices when data is transferred at a high speed.

The 4-bit buffers 402, 412, 422 and 432 have a function to temporarily store 4-bit data, and perform data input/output with signal lines 441, 447, 448 and 449 and with the parallel-to-serial converters.

NAND circuits 403, 413, 423 and 433 operate when data is read by the normal method, when data is written by the normal method, when data is read by the differential signal method, and when data is written by the differential signal method, respectively. Also, each of the NAND circuits 403, 413, 423 and 433 has a function to convey to a connection-destination buffer or parallel-to-serial converter that an operation is required, when both input signals are true. Signal lines 406 and 416 are used to perform normal clock inputs. Signal lines 426 and 436 are used to perform high-speed clock inputs for the differential signal method.

The 4-bit buffers 402, 412, 422 and 432 are connected to the signal lines 441, 447, 448 and 449. The signal lines 441, 447, 448 and 449 are respectively connected to the connection terminals 1, 7, 8, 9.

<Operation>

1. Operation of SD Card

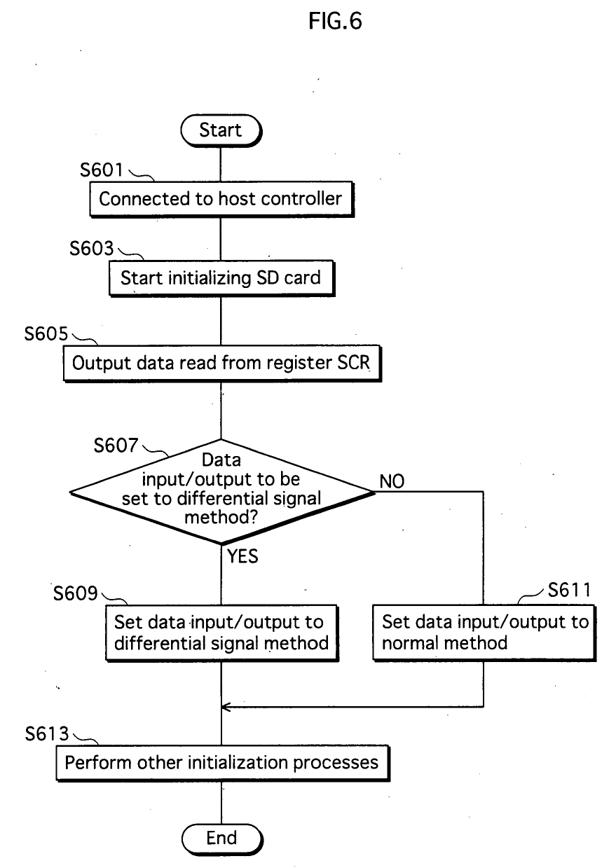

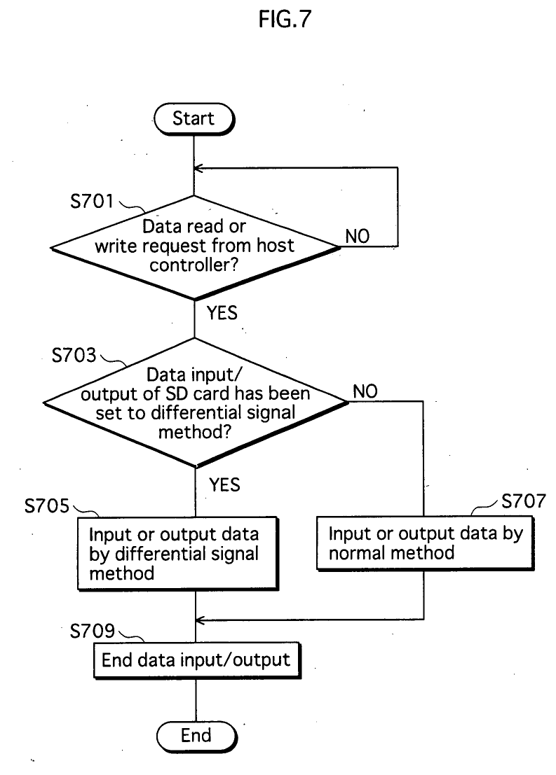

The operation of the SD card 100 in the present embodiment will be described with reference to the flowcharts shown in FIGS. 6 and 7.

First, the initialization performed when the SD card is connected to the host controller will be described with reference to the flowchart shown in FIG. 6.

First, the SD card 100 is inserted into the host controller 120 by the user (step S601). The initialization process of the SD card is started as the SD card is connected (step S603). The interface driver 101 reads, from the memory 102, the information indicating that the SD card itself supports the data transfer by the differential signal method, and outputs the read information to the host controller 120 via the terminal 1 (step S605). A data input/output method setting request is then received from the host controller 120, and it is judged whether the requested method is the differential signal method (step S607). If it is judged that the requested method is the differential signal method (Yes in step S607), information indicating that the data input/output is performed by the differential signal method is stored in the setting register of the SD card, and the subsequent data inputs/outputs are performed by the differential signal method. Then, other initialization processes such as detecting the capacity of the SD card, detecting the state of the SD card and the like are performed (step S613), and the initialization process is ended. If it is judged that the requested method is the normal method (No in step S607), information indicating that the data input/output is performed by the normal method is stored in the setting register of the SD card, and the subsequent data inputs/outputs are performed by the normal method. It should be noted here that the initialization process needs to be performed only once when the SD card is connected to the host controller, but need not be performed each time the data input/output is performed. However, when the SD card is detached from the host controller and then inserted again, the initialization process needs to be performed.

Next, the data input/output operation of the SD card will be explained with reference to FIG. 7. First, the SD card receives a data read request or a data write request from the host controller 120 via the connection terminal 2 (Yes in step S701). If no request has been received (No in step S701), the SD card 100 is in a wait state.

When it receives a data read request or a data write request, the SD card 100 checks if the data input/output of the SD card itself has been set to the differential signal method (step S703). If it judges that the data input/output has been set to the differential signal method (Yes in step S703), the SD card performs data input/output by the differential signal method (step S705). If it judges that the data input/output has been set to the normal method (No in step S703), the SD card performs data input/output by the normal method (step S707).

After all data instructed by the host controller 120 has been input or output, the process ends (step S709).

2. Operation of Host Controller

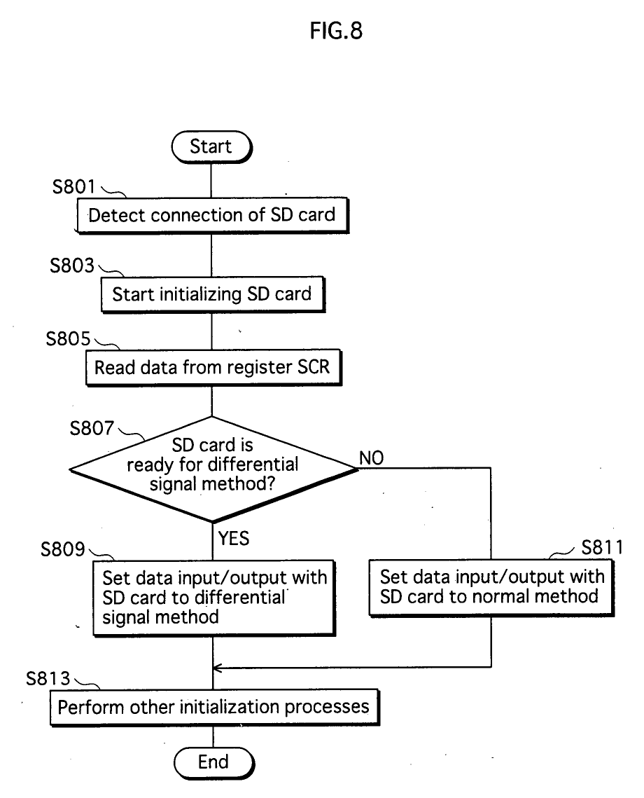

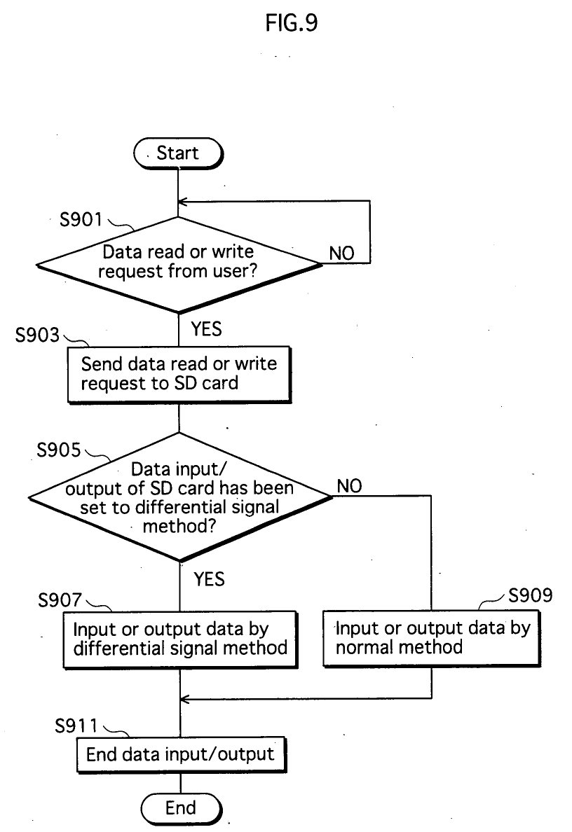

The following will describe the operation of the host controller 120 with reference to the flowcharts shown in FIGS. 8 and 9.

First, the operation of the host controller 120 in the initialization of the SD card 100 will be described.

First, the SD card 100 is inserted into the host controller 120 by the user, and the host controller 120 detects the insertion of the SD card (step S801). The host controller 120 starts the initialization process of the SD card as it detects the insertion of the SD card (step S803). First, the host controller 120 reads data of the SD card from the register SCR in the SD card (step S805), and judges whether or not the SD card supports the differential signal method (step S807).

If it judges that the SD card supports the differential signal method (Yes in step S807), the host controller 120 sets the data input/output method of the SD card to the differential signal method (step S809). On the other hand, if it judges that the SD card does not support the differential signal method (No in step S807), the host controller 120 sets the data input/output method of the SD card to the normal method (step S811). The host controller 120 then performs other initialization processes (step S813), and ends the process. It should be noted here that the initialization process needs to be performed only once when the SD card is connected to the host controller, but need not be performed each time the data input/output is performed. However, when the SD card is detached from the host controller and then inserted again, the initialization process needs to be performed.

Next, the operation of the host controller 120 in the data input/output will be described with reference to the flowchart shown in FIG. 9.

The host controller 120 checks whether or not a data read request or a data write request has been input by the user (step S901). If it judges that a data read request or a data write request has been input (Yes in step S901), the host controller 120 sends the data read request or data write request to the SD card via the connection terminal 12 (step S903). The host controller 120 then judges whether or not the data input/output of the SD card has been set to the differential signal method (step S905). If it judges that the data input/output of the SD card has been set to the differential signal method (Yes in step S905), the host controller 120 performs data input/output by the differential signal method (step S907). If it judges that the data input/output of the SD card has been set to the normal method (No in step S905), the host controller 120 performs data input/output by the normal method (step S909). The host controller 120 then ends the process if it has completed the input/output of the specified data (step S911).

3. Operation of Switching Mechanism

Next, the switching operation will be described with reference to FIG. 4 that shows the structure for the switching function. Here will be described the case of the SD card, although the host controller 120 has the same mechanism. The operation of the host apparatus 130 is omitted since there is only a slight difference between them: the SD card performs the switching based on the command received from the host apparatus 130 via the connection terminal 2, while the host controller 120 performs the switching based on the command that is directly received from the host apparatus 130.

When a data read into the host apparatus is performed by the normal method, that is to say, when the SD card outputs data to the host controller, the SD card receives signals via the connection terminal 2, and the host controller receives an instruction from the CPU of the host apparatus, and a signal indicating a data output by the normal method flows in the signal line 404, and a signal indicating a read request flows in the signal line 405. The two signals are combined by the NAND circuit 403, and the combined signal is conveyed to the 8-bit buffer 400, the 8-bit-to-4-bit parallel-to-serial converter 401, and the 4-bit buffer 402 to start the data output. It should be noted here that each circuit operates at the operation timing of the normal clock that is input via the signal line 406. In the case of the SD card, the normal clock is supplied as a base from the host controller 120 via the connection terminal 5. In the case of the host controller 120, the normal clock is supplied as a base from a clock generation device provided in the host apparatus 130. The NAND circuit is used because it makes it easier to manufacture the real machine than the AND circuit.

The 8-bit buffer 400 temporarily stores data that is sent thereto via the data bus 450, and outputs the data to the 8-bit-to-4-bit parallel-to-serial converter 401. The 8-bit-to-4-bit parallel-to-serial converter 401 converts the data that is output from the 8-bit buffer 400 as parallel data in units of eight bits, to serial data of four bits, and outputs the converted data to the 4-bit buffer 402. The 4-bit buffer 402 outputs data via the signal lines 441, 447, 448, and 449. Each of the signal lines 441, 447, 448, and 449 transfers a different one bit of the data, each bit value being represented by the height of potential.

Next, when a data write to the SD card is performed by the normal method, that is to say, when the SD card receives data from the host controller, a signal indicating a data input/output by the normal method flows in the signal line 414, and a signal indicating a data write flows in the signal line 415. The combined signal is conveyed to the 8-bit buffer 410, the 4-bit-to-8-bit serial-to-parallel converter 411, and the 4-bit buffer 412 to start the data write by the normal method.

The 4-bit buffer 412 receives data from the host controller via the signal lines 441, 447, 448, and 449, and temporarily stores the received data, and outputs the data to the 4-bit-to-8-bit serial-to-parallel converter 411. The 4-bit-to-8-bit serial-to-parallel converter 411 converts the data that is output from the 4-bit buffer 412 as serial data in units of four bits, to parallel data of eight bits, and outputs the converted data to the 8-bit buffer 410. The 8-bit buffer 410 sends the received data to the memory via the data bus 450. The data write operation is completed when all the data has been stored in the memory. It should be noted here that each circuit operates at the operation timing of the normal clock that is input via the signal line 416. In the case of the SD card, the normal clock is supplied as a base from the host controller 120 via the connection terminal 5. In the case of the host controller 120, the normal clock is supplied as a base from a clock generation device (not illustrated) provided in the host apparatus 130.

Next, a data read by the differential signal method will be described.

The SD card receives signals via the connection terminal 2, as an instruction from the CPU of the host apparatus, and a signal indicating a data output by the differential signal method flows in the signal line 424, and a signal indicating a read request flows in the signal line 425. The two signals are combined by the NAND circuit 423, and the combined signal is conveyed to the 8-bit buffer 420, the 8-bit-to-2-bit parallel-to-serial converter 421, and the 4-bit buffer 422 to start the data output.

The 8-bit buffer 420 temporarily stores data that is sent thereto via the data bus 450, and outputs the data to the 8-bit-to-2-bit parallel-to-serial converter 421. The 8-bit-to-2-bit parallel-to-serial converter 421 converts the data that is output from the 8-bit buffer 420 as parallel data in units of eight bits, to serial data of two bits, and outputs the converted data. The output data is converted by the differential signal generators 427 and 428 into differential signals. The differential signals are temporarily stored in the 4-bit buffer 422. The 4-bit buffer 422 outputs the data via the signal lines 441, 447, 448, and 449. Each of the signal lines 441, 447, 448, and 449 transfers a different one bit of the data, each bit value being represented by the height of potential. It should be noted here that each circuit operates at the operation timing of the high-speed clock that is input via the signal line 426. In the case of the SD card, the high-speed clock is supplied as a base from the host controller 120 via the connection terminal 5. In the case of the host controller 120, the high-speed clock is supplied as a base from a high-speed clock generation device, which generates the high-speed clock that is faster than the normal clock, provided in the host apparatus 130.

Finally, a data write by the differential signal method will be described.

A signal indicating a data input/output by the differential signal method flows in the signal line 434, and a signal indicating a data write flows in the signal line 435. The combined signal is conveyed to the 8-bit buffer 430, the 2-bit-to-8-bit serial-to-parallel converter 431, and the 4-bit buffer 432 to start the data write by the differential signal method.

The 4-bit buffer 432 receives a 4-bit differential signal from the host controller via the signal lines 441, 447, 448, and 449, and temporarily stores the received data, and outputs the data. The differential signal restoring units 437 and 438 restore, from the output 4-bit differential signal, a 2-bit normal signal, and outputs the 2-bit normal signal to the 2-bit-to-8-bit serial-to-parallel converter 431. The 2-bit-to-8-bit serial-to-parallel converter 431 converts the received data that has been output in units of two bits, to parallel data of eight bits, and outputs the converted data to the 8-bit buffer 430. The 8-bit buffer 430 sends the received data to the memory 102 via the data bus 450. The data write operation is completed when all the data has been stored in the memory 102. It should be noted here that each circuit operates at the operation timing of the high-speed clock that is input via the signal line 436. In the case of the SD card, the high-speed clock is supplied as a base from the host controller 120 via the connection terminal 5. In the case of the host controller 120, the high-speed clock is supplied as a base from a high-speed clock generation device, which generates the high-speed clock that is faster than the normal clock, provided in the host apparatus 130.

<Supplementary Notes>

Up to now, an SD card of the present invention and a host controller have been described through an embodiment. However, the present invention is not limited to the embodiment, but may be modified in various ways. The following are examples of such modifications.
(1) In the above-described embodiment, the SD card conforms to the current standard. However, when the standard of the SD card is modified (for, example, the number of terminals is changed), the SD card of the present invention is to be modified to conform to the modified standard.
(2) In the above-described embodiment, the host controller judges whether or not the SD card supports the differential signal method, by reading the information indicating it from the SCR. However, not limited to the SCR, the information may be stored in another storage area. For example, the information may be stored in a function status register. The use of the information may be replaced by a method in which, upon receiving a dedicated signal from the host controller side, the SD card returns a signal having a special waveform to indicate that the SD card supports the differential signal method.

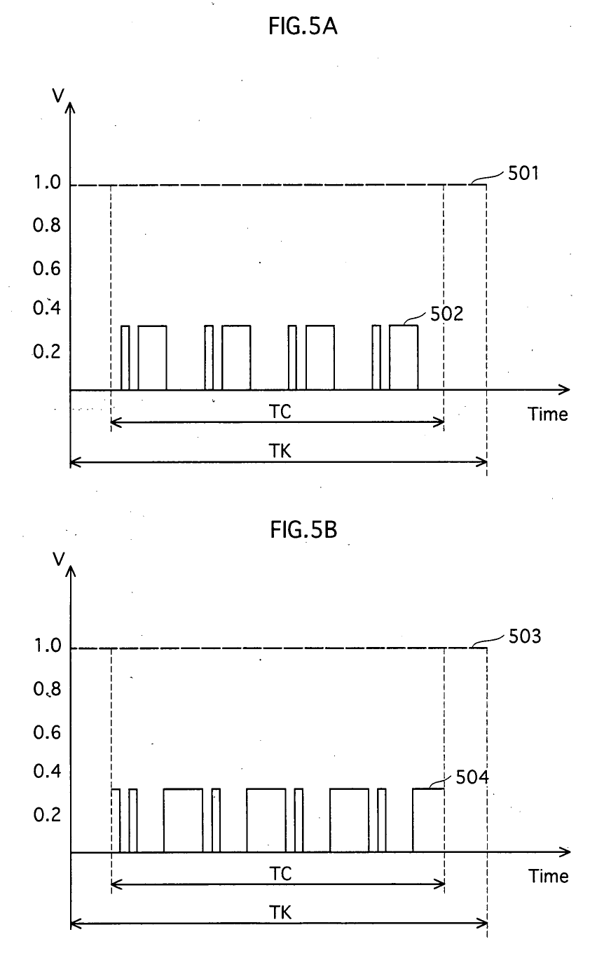

This method can be performed as follows, for example. As shown in FIGS. 5A and 5B, the host controller side transmits a voltage to the connection terminals 1 and 9 for a predetermined time period TK which is indicated by the dashed lines 501 and 503. If the SD card supports data input/output by the differential signal method, the SD card returns a signal 502 or 504 having a waveform of a predetermined pattern for a time period TC within the time period TK so that the host controller side can recognize that the SD card supports the differential signal method. It should be noted here that the waveforms of the signals 502 and 504 are determined in advance.
(3) In the above-described embodiment, the terminals 1, 7, 8, and 9 are used for performing data input/output. However, this is one example of the pin arrangement. Not limited to these, a more number of terminals may be used for performing data input/output, for example. However, it is preferable that the two terminals used for transferring differential signals are arranged to be adjacent to each other.
(4) In the above-described embodiment, the SD card 100 and the host controller 120 both support the normal method and the differential signal method. However, when the SD card comes to perform data input/output only by the differential signal method, the host controller may also be structured to perform data input/output only by the differential signal method, and the switching mechanism may be omitted from the structure. The present invention is presumed to be applicable to the SD card in the transitional period from the normal method to the differential signal method. When the SD card has come to perform data input/output only by the differential signal method, the switching mechanism is no longer needed.
(5) In the above-described embodiment, the high-speed clock generation device generates high-speed clocks. However, the normal clock may be multiplied, and the multiplied clock may be input into the circuit via the signal lines 426 and 436 as a high-speed clock.
(6) In the above-described embodiment, only the term “SD card” is used. However, the “SD card” used in this document refers to every type of SD card, such as an SD memory card, SD I/O card, mini SD card, micro SD card, and smart SD card.
(7) In the above-described embodiment, the differential signal method is explained as the voltage differential signal method. In the voltage differential signal method, as described in the embodiment, a difference of one signal line from the other signal line in voltage value is obtained, and if the difference is greater than a threshold value, the data is regarded as “1”; and if the difference is equal to or smaller than the threshold value, the data is regarded as “0”. However, it is not limited to the difference in voltage value.

For example, a difference between values of electric currents, which flow in two terminals and signal lines connected thereto, may be used to determine “1” and “0”.

This is realized by setting two types of values of electric currents, which flow in the host controller, or flow in the terminals inside the SD card and signal lines connected thereto, to “0.3 mA” and “−0.3 mA”, respectively. If a difference between two types of values of electric currents is equal to or greater than a threshold value, the data may be regarded as “1”, and if the difference is smaller than the threshold value, the data may be regarded as “0”. Here, the threshold value may be “0.3”, for example.

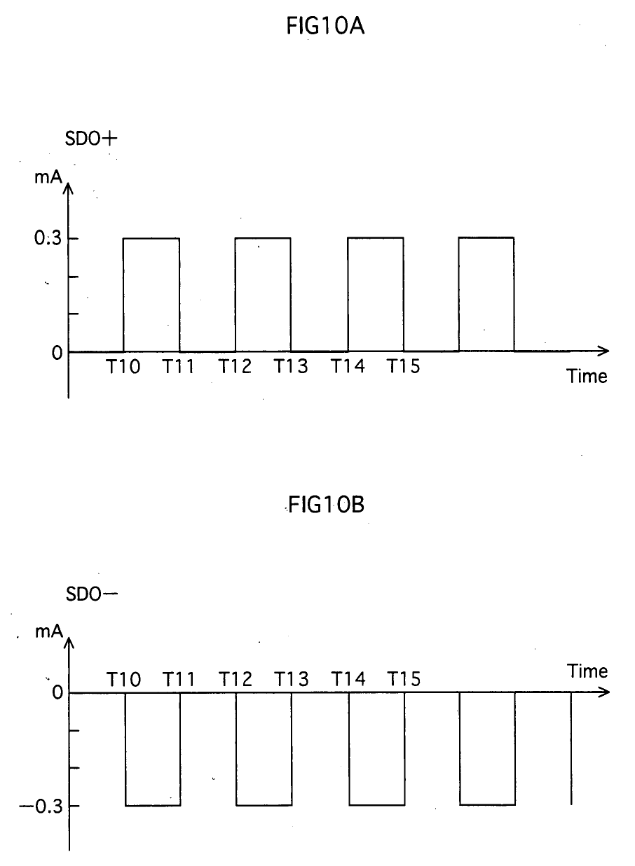

FIGS. 10A and 10B show an example of the waveforms of the currents that flow in the two terminal.

For example, at times T10-T11 or times T12-T13, a current of 0.3 mA is flowing in SDO+ as shown in FIG. 10A, and a current of −0.3 mA is flowing in SDO− as shown in FIG. 10B. In this case, the difference of SDO+ from SDO− is obtained as SDO+−SDO−=0.3−(−0.3)=0.6 mA. Accordingly, the data is regarded as “1”.

On the other hand, at times T11-T12 or times T13-T14, no current is flowing in SDO+ as shown in FIG. 10A, and no current is flowing in SDO− as shown in FIG. 10B. In this case, the difference of SDO+ from SDO− is obtained as SDO+−SDO−=0−0=0 mA. Accordingly, the data is regarded as “0”.

In this way, two currents whose values are antiphase to each other may be flown in the two terminals and signal lines connected thereto. This makes it possible to cancel out the influences of the high frequencies that are generated by the currents that flow in terminals and signal lines connected thereto.

Also, both the SD card and the host controller may support the voltage differential signal method and the current differential signal method. In this case, required to be provided is a switching unit for switching between the methods, or a detector for detecting which of the methods is available in a partner of the data input/output.
(8) In the above-described embodiment, the data transfer speed is not specifically explained. However, since the USB2.0 standard defines a plurality of data transfer speeds (1.5 Mbps, 12 Mbps, and 480 Mbps), the SD card and the host controller of the present invention may be structured to support a plurality of data transfer speeds.

In this case, the SD card holds information indicating data transfer speeds that are available in the SD card itself. The host controller specifies a data transfer speed via a command pin. The host controller and the SD card perform the data input/output at the specified data transfer speed.
(9) The present invention is also a data transfer method for the SD card and the host controller disclosed in the above-described embodiment. The present invention is further a computer program for causing a computer to perform the procedures of the data transfer method.

### INDUSTRIAL APPLICABILITY

The present invention is applicable to an SD card and a host controller to which the SD card is connected.

1. An SD card that includes a plurality of terminals and performs data input/output while being inserted in an external device, the SD card comprising:
a normal input/output control unit operable to perform data input/output one bit by one bit via one terminal;
a differential signal input/output control unit operable to perform data input/output one bit by one bit via two terminals by a differential signal method; and
a switching unit operable to cause either of the normal input/output control unit and the differential signal input/output control unit to perform data input/output by switching therebetween in accordance with a request from the external device.

2. The SD card of claim 1, wherein
the terminal via which the normal input/output control unit performs data input/output is one of the two terminals via which the differential signal input/output control unit performs data input/output.

3. The SD card of claim 1, wherein
the two terminals are rectangular metal pieces arranged such that length directions thereof are substantially parallel to each other.

4. The SD card of claim 1, wherein
the two terminals are arranged to be adjacent to each other.

5. The SD card of claim 1, wherein
the plurality of terminals include a reception terminal operable to receive the request from the external device in which the SD card is inserted.

6. The SD card of claim 1 further comprising:
a storage unit storing data; and
another normal input/output control unit, wherein
the normal input/output control units perform data input/output one bit by one bit respectively via the two terminals via which the differential signal input/output control unit performs data input/output, and
the switching unit causes the differential signal input/output control unit to perform data input/output two times by time division between the storage unit and the external device in which the SD card is inserted, to transfer an amount of data that can be transferred by the two normal input/output control units at one time.

7. The SD card of claim 1, wherein
the differential signal input/output control unit performs data input/output by a voltage differential signal method in which a data value is defined by a difference between voltages applied to two terminals.

8. The SD card of claim 1, wherein
the differential signal input/output control unit performs data input/output by a current differential signal method in which a data value is defined by a difference between values of currents that flow in two terminals.

9. The SD card of claim 1, wherein
the differential signal input/output control unit performs data input/output by either of a voltage differential signal method and a current differential signal method, wherein in the voltage differential signal method, a data value is defined by a difference between voltages applied to two terminals, and in the current differential signal method, a data value is defined by a difference between values of currents that flow in two terminals.

10. The SD card of claim 1, wherein
the differential signal input/output control unit performs data input/output by changing a data transfer speed as necessary.

11. The SD card of claim 10, wherein
the differential signal input/output control unit changes the data transfer speed in accordance with a request that indicates a data transfer speed and is received by the reception terminal from the external device in which the SD card is inserted.

12. A host controller that performs a data communication with an SD card inserted therein, via a plurality of terminals provided in the host controller, the host controller comprising:
a normal input/output control unit operable to perform data input/output one bit by one bit via one terminal;
a differential signal input/output control unit operable to perform data input/output one bit by one bit via two terminals by a differential signal method;
a reading unit operable to read information indicating whether the inserted SD card supports data input/output by the differential signal method; and
a switching unit operable to cause either of the normal input/output control unit and the differential signal input/output control unit to perform data input/output by switching therebetween in accordance with whether the inserted SD card supports data input/output by the differential signal method.

13. The host controller of claim 12, wherein
the terminal via which the normal input/output control unit performs data input/output is one of the two terminals via which the differential signal input/output control unit performs data input/output.

14. The host controller of claim 12, wherein
the two terminals are rectangular metal pieces arranged such that length directions thereof are substantially parallel to each other.

15. The host controller of claim 12, wherein
the two terminals are arranged to be adjacent to each other.

16. The host controller of claim 12, wherein
the plurality of terminals include a conveyance terminal operable to convey a request to the inserted SD card.

17. The host controller of claim 12 further comprising:
a storage unit storing data; and
another normal input/output control unit, wherein
the normal input/output control units perform data input/output one bit by one bit respectively via the two terminals via which the differential signal input/output control unit performs data input/output, and
the switching unit causes the differential signal input/output control unit to perform data input/output two times by time division between the storage unit and the external device in which the SD card is inserted, to transfer an amount of data that can be transferred by the two normal input/output control units at one time.

18. The host controller of claim 12 further comprising
a voltage supply unit operable to supply a voltage to the SD card for an operation thereof, wherein
the switching unit changes the voltage to be supplied to the SD card, depending on which of the normal input/output control unit and the differential signal input/output control unit performs data input/output.

19. The host controller of claim 12 further comprising
a differential signal converting unit operable to generate or combine differential signals, wherein
data lines connecting the differential signal converting unit with the two terminals, via which the differential signal input/output control unit performs data input/output, are provided substantially in parallel with each other.

20. The host controller of claim 12, wherein
the reading unit includes:
a voltage generating unit operable to generate a voltage that is higher than a voltage used for a data transfer by the differential signal input/output control unit;
an output unit operable to output the voltage generated by the voltage generating unit to the inserted SD card; and
a response reading unit operable to read a response waveform of a response of the SD card to the voltage output by the output unit, for a predetermined time period, wherein
if the response reading unit reads a response waveform indicating that the inserted SD card supports data input/output by the differential signal method, the switching unit causes the differential signal input/output control unit to perform data input/output.

21. The host controller of claim 12, wherein
the differential signal method is a voltage differential signal method in which a data value is defined by a difference between voltages applied to two terminals.

22. The host controller of claim 12, wherein
the differential signal method is a current differential signal method in which a data value is defined by a difference between values of currents that flow in two terminals.

23. The host controller of claim 12, wherein
the differential signal input/output control unit performs data input/output by either of a voltage differential signal method and a current differential signal method, wherein in the voltage differential signal method, a data value is defined by a difference between voltages applied to two terminals, and in the current differential signal method, a data value is defined by a difference between values of currents that flow in two terminals.

24. The host controller of claim 12, wherein
the differential signal input/output control unit performs data input/output by changing a data transfer speed as necessary.

25. The host controller of claim 24, wherein
the differential signal input/output control unit conveys, via the conveyance terminal, a request that indicates a data transfer speed to the inserted SD card, and performs data input/output at the data transfer speed indicated by the request.

26. A data input/output method for an SD card, comprising:
a normal input/output control step for performing data input/output one bit by one bit via one terminal;
a differential signal input/output control step for performing data input/output one bit by one bit via two terminals by a differential signal method; and
a switching step for causing either of the normal input/output control unit and the differential signal input/output control unit to perform data input/output by switching therebetween in accordance with a request from an external device in which the SD card is inserted.

27. A data input/output method for a host controller that performs a data communication with an SD card inserted therein, via a plurality of terminals provided in the host controller, the data input/output method comprising:
a normal input/output control step for performing data input/output one bit by one bit via one terminal;
a differential signal input/output control step for performing data input/output one bit by one bit via two terminals by a differential signal method;
a reading step for reading information indicating whether the inserted SD card supports data input/output by the differential signal method; and
a switching step for causing either of the normal input/output control unit and the differential signal input/output control unit to perform data input/output by switching therebetween in accordance with whether the inserted SD card supports data input/output by the differential signal method.

28. A data input/output program for causing a computer loaded in an SD card to perform data input/output, the data input/output program causing the computer to perform:
a normal input/output control step for performing data input/output one bit by one bit via one terminal;
a differential signal input/output control step for performing data input/output one bit by one bit via two terminals by a differential signal method; and
a switching step for causing either of the normal input/output control unit and the differential signal input/output control unit to perform data input/output by switching therebetween in accordance with a request from an external device in which the SD card is inserted.

29. A data input/output program for causing a computer loaded in a host controller to perform a data communication with an SD card inserted therein, via a plurality of terminals provided in the host controller, the data input/output program causing the computer to perform:
a normal input/output control step for performing data input/output one bit by one bit via one terminal;
a differential signal input/output control step for performing data input/output one bit by one bit via two terminals by a differential signal method;
a reading step for reading information indicating whether the inserted SD card supports data input/output by the differential signal method; and
a switching step for causing either of the normal input/output control unit and the differential signal input/output control unit to perform data input/output by switching therebetween in accordance with whether the inserted SD card supports data input/output by the differential signal method.
